(19) United States
(12) Patent Application Publication
(10) Pub. No.: US 2023/0230004 A1
(43) Pub. Date: Jul. 20, 2023

(54) Matching Natural Gas Production with Contractual Quantities using Normalized Models

(71) Applicant: Saudi Arabian Oil Company, Dhahran (SA)

(72) Inventors: Bryan Hall-Thompson, Aberdeenshire (IE); Abdulrahman Nutaifi, Al Khobar (SA); Umar A. Al-Nahdi, Dammam (SA); Razen M. Alharbi, Dammam (SA)

(21) Appl. No.: 17/648,207

(22) Filed: Jan. 18, 2022

(51) Int. Cl. G06Q 10/06; G06Q 30/02; G06Q 50/04

(52) U.S. Cl. CPC G06Q 10/06315; G06Q 30/0202; G06Q 50/04

(57) ABSTRACT

An exemplary method provides matching natural gas subsurface production to contractual quantities or demand. A demand for hydrocarbons and an unconstrained supply from multiple reservoirs according to one or more unconstrained subsurface supply parameters are determined. A constrained supply is calculated according to parameterized constraints associated with wells, facilities, and processing systems of the unconstrained subsurface supply parameters according to a selected model option. Hydrocarbons quantities in the constrained supply are matched with the demand for hydrocarbons.

### TECHNICAL FIELD

The present disclosure describes matching natural gas production with required contractual quantities using normalized models and, more particularly, matching natural gas subsurface production to contractual quantities using normalized, machine learning and physics models.

### BACKGROUND

Hydrocarbons such as natural gas are produced for consumption. The quantities of hydrocarbons produced can vary, while demand for hydrocaarbons is specified by contracts. In some cases, the demand is equivalent to the produced hydrocarbon quantities. In some cases, the demand is greater than or less than the produced hydrocarbon quantities and therefore a system to match a demand and supply is necessary as part of the gas production system

### SUMMARY

An embodiment described herein provides a computer-implemented method for matching natural gas subsurface production to contractual quantities. The method includes determining a demand for hydrocarbons and determining an unconstrained supply from multiple reservoirs according to one or more unconstrained subsurface supply parameters. The method includes calculating a constrained supply according to parameterized constraints associated with wells, facilities, and processing systems of the unconstrained subsurface supply parameters according to a selected model option. Additionally, the method includes matching hydrocarbon quantities in the constrained supply with the demand for hydrocarbons.

An embodiment described herein provides a system including at least one processor and at least one memory storing instructions thereon that, when executed by the at least one processor, cause the at least one processor to determine a demand for hydrocarbons and determine an unconstrained supply from multiple reservoirs according to one or more unconstrained subsurface supply parameters. The instructions cause the at least one processor to calculate a constrained supply according to parameterized constraints associated with wells, facilities, and processing systems of the unconstrained subsurface supply parameters according to a selected model option. Further, the instructions cause the at least one processor to match hydrocarbon quantities in the constrained supply with the demand for hydrocarbons.

An embodiment described herein provides at least one non-transitory storage media storing instructions that, when executed by at least one processor, cause the at least one processor to determine a demand for hydrocarbons and determine an unconstrained supply from multiple reservoirs according to one or more unconstrained subsurface supply parameters. The instructions cause the at least one processor to calculate a constrained supply according to parameterized constraints associated with wells, facilities, and processing systems of the unconstrained subsurface supply parameters according to a selected model option. Further, the instructions cause the at least one processor to match hydrocarbon quantities in the constrained supply with the demand for hydrocarbons.

### BRIEF DESCRIPTION OF DRAWINGS

FIG. 1 is a block diagram of a method for matching natural gas subsurface production to contractual quantities or demand.

FIG. 2 is an illustration of exemplary well normalization derived from machine learning that can be used for model initialization and prediction of a well supply.

FIG. 3 is a process flow diagram of a process for matching natural gas production with contractual quantities using normalized models.

FIG. 4 is a schematic illustration of an example controller for matching natural gas production with contractual quantities using normalized models according to the present disclosure.

### DETAILED DESCRIPTION

Embodiments described herein enable matching natural gas production with contractual quantities using normalized models. Generally, hydrocarbons are produced and provided in quantities specified by contracts or by consumer demand. The present techniques conduct and achieve a match between contracted quantities/demand and produced hydrocarbon volumes, wherein the hydrocarbons are produced from single to multiple gas reservoirs, wells, production facilities and midstream processing and transport facilities. The present techniques utilize physics models, machine learning models and proposed normalized parameters types in four categories: wells performance factors, facilities operations factors, reservoir or subsurface factors, and business process and financial factors. The present techniques reduce the computational requirements required for large scale demand and supply matching by creating weight factors for every gas well, platform, or manifold. In examples, weights or factors between a scale of between 0 and 1 are created for each of the four normalization categories. The normalized options reduce physics requirements and provides ease of computation hence it is the preferred option in large scale demand and supply matching operations.

The present techniques match multi-field gas demand versus subsurface supply using minimization of an objective cost function as opposed to optimizing production through maximization of objective cost functions. The present techniques include a minimization of the difference between contractual demand and subsurface supply and also the difference between sales gas revenues at specific prices versus the unit costs for each asset. For ease of description, the production of hydrocarbons is modeled as a graph with nodes, wherein supply nodes include wells, production facilities, and midstream processing and transport facilities considered as vertices in a graph. The relationships so established correspond to concepts in graph theory. No assumption is made about directionality between vertices of the graph.

The present techniques determine matches between hydrocarbon gas demand and hydrocarbon gas supply from single or multiple reservoirs by using multiple normalized parameter types as weights that include: normalized wells performance, normalized facilities operations, normalized subsurface characteristics and normalized business process and financial factors. These are collectively referred to as the four options and used in physics or machine learning options. For ease of description, contractual requirements and demand are referred to in the context of natural gas production. However, the present techniques can be applied if any of these products are considered as the primary stream to be optimized.

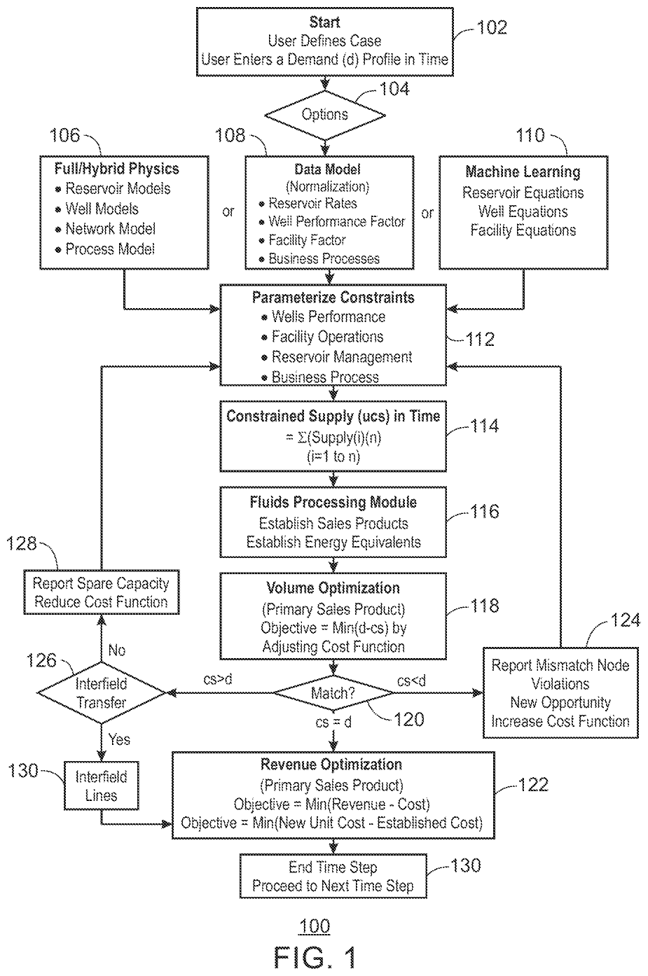

FIG. 1 is a block diagram of a process 100 for matching natural gas subsurface production to contractual quantities or demand. In embodiments, the process 100 is a tool that matches produced hydrocarbons with demand or contractual obligations. At block 102, a user defines the demand. For example, a user enters a demand (d) profile with a time value. In particular, a business user enters net gas demand requirements after considering all products streams such as various oils, condensates and any alternative energy equivalent to be produced across multiple field level. In examples, a business user refers to a hydrocarbon gas customer or a representative of a hydrocarbon gas customer. In many instances a business user is a non-technical user who has limited knowledge of the technicalities of a reservoir and well models. The business user utilizes the platform to state the demand or how much gas is required. This user makes such request through the platform inputs or to the operator, or via a technical user of the platform who applies the present techniques to meet and match the given demand. In examples, a technical user is one who understands the technicalities of reservoir, subsurface and wells production systems. A technical user refers to reservoir engineers, gas supply planning engineers, gas production engineers, production technologists and persons knowledgeable in the estimation, prediction and optimization of gas production from full field models that include reservoir, production wells and gathering systems. In some cases, the technical user also refers to users that will utilize the proposed method to achieve a gas demand and supply match.

In embodiments, to determine the net gas demand, an assessment of all product streams is done externally by the business user. For example, determining net gas demand involves assessing how much energy is available to customers and how much of gas is required to meet such energy demand. This also includes how much associated gas is produced from other oil operations. Using these quantified associated gas volumes estimate, the actual demand gas is set. This is the total gas required by the customers on the network excluding any associated gas produced from connected oilfields. Also considered before determining the gas demand is the volumes of other hydrocarbon streams such as ethane, propane etc. The volume of all existing products is accounted for separately by the business user to ensure that no excesses or undersupply is provided by the model.

At block 104, the model that will predict the supply, well performance, reservoir predictions, network models etc. is selected. In embodiments, the present techniques select between the hybrid/full physics model, data model, and machine learning model using radio buttons that are controlled from a visualization platform. Based on the choice, the present techniques enable a connection with the models using an API or at present codes in either python or visual basic to connect to the machine learning models, physics wells and facility models, or remain on the present platform to use the normalization or data driven model. In embodiments, when multiple objective or products are to be matched, an option is added to the selection stage to compel the platform to use a physics model. This enables a technical user to refine the product stream prediction using advanced fluid and reservoir PVT models to capture the compositional changes in streams via the physics model.

At block 106, the full/hybrid physics model is selected. The fully/hybrid physics model includes reservoir models, well models, network models, and process models. At block 108, the data model is selected. The data model includes normalization or scaling between 0 and 1 of designed or historical reservoir rates, wells rates, facility rates and given business constraints such as strategic restriction of production capacity. These scaled parameters are termed reservoir management factor (rm), well performance factors (wp), facility operations factors (fo), and business processes factor (bp). At block 110, a machine learning model is selected. The machine learning model includes reservoir equations, well equations, and facility equations that are based on various linear, nonlinear and logistic regression, batch gradient descent, neural networks techniques etc.

Each of the full/hybrid physics model 106, data model 108, and machine learning model 110 are used to parameterize constraints. A user (business or technical user) derives based on these constraints or enters a total and unconstrained supply in time from multiple reservoirs for input to the models. The total and unconstrained supply refers to the maximum the reservoir or multiple reservoirs can produce in relation to the total capacity designed and installed for the gas fields (nameplate capacities). The rate assumes that all wells and facilities within the production network can meet this condition or capacities.

At this stage other parameters such as fluid properties, maximum well rates, maximum transport and processing capacities can be entered. In embodiments, the technical user derives unconstrained subsurface supply parameters externally and enters these values or has the option to utilize models based on physics or machine learning. For example, an external entry method is used where the technical user specifies these forecast as obtained from a reservoir simulation or similar model. Another external entry can be from data available in planning databases that specify the expected reservoir rate with time. If the physics model option is selected, then any connected material balance model or reservoir simulator can forecast the unconstrained supply with time.

Generally, the total and unconstrained supply refers to the maximum the reservoirs can produce in relation to the total capacity designed and installed for the gas fields (e.g., nameplate capacities). The total capacity is a sum of normal operating capacity any extra contingent capacities and any external capacity connected by transfer means such as pipeline to the gas field. Some types of unconstrained supply are: 1) rate vs cumulative production profiles for given initial gas volumes with time; 2) reservoir material balance including P/Z Models; and 3) prediction forecasts from advanced physics based numerical models; 4) total rate vs time in years months or period as specified by user; and 5) all forms of reservoir prediction applied to hydrocarbon prediction. The technical user then proceeds to parameterize wells, facilities and processing systems for whichever computation option full physics data normalization model or machine learning that is selected. This parameterization includes the constraints associated with the four constraints option described herein. The technical user solves the first un-optimized constrained supply that can be achieved from each well, platform and process systems. In embodiments, the user solves for the un-optimized constraints to evaluate the maximum capacity possible based on constraints identified or imposed on the system using the factors. This establishes a base line to commence minimizing the differences between constrained supply and required customer demand necessary to achieve a time step match. It is the start of the iteration process and sets the maximum deliverability that can be obtained based on the constraints at the start of a time step. The un-optimized supply constraint is also useful in evaluating spare capacities or any undeveloped opportunity reported according to the present techniques. In embodiments, the process 100 solves for the un-optimized constrained supply at first time step=0 by summing the supply from all wells in the system after applying weights from all factors as expressed for each well (i) by Equation 4 below that calculates a supply for each well. More specific, if the physics and machine learning options are selected, reservoir prediction and facilities models are included or can be connected to the tool using software communication protocols such as API, programmed scripts etc. These included models can derive the un-optimized constrained supply using their internal algorithms.

At block 114, all constrained supply for the time step is summed and send this to a fluid module that utilizes the product compositions to process the fluids and derive rates of commercial effluents such as methane, ethane, propane, butane etc. Generally, the constrained supply is derived from the product of the unconstrained supply and all four factors: well performance, facility operations (capacity), reservoir or subsurface limitations and business decision factors. The constrained supply is determined based on well performance, facility operations (capacity), reservoir or subsurface limitations and business decision factors. These parameters are considered as weighting parameters to achieve minimization needed to match demand and supply.

At block 116, the fluid module or model is solved using the given PVT or fluid properties for the calculated raw gas rate. The fluid can use any of four liquid extraction processes to derive quantities of gaseous stream methane and ethane, Natural gas liquid streams and Liquid streams. In embodiments, a technical user views the un-optimized results at this stage. In embodiments, the technical user can view the un-optimized results to establish as an example the dominant effluent type such as methane, ethane, propane etc. Based on these early results the demand supply match objective can be changed to focus on the matching a particular effluent e.g. ethane. Another reason for this is to ensure that the best of the four suggested commercial process such as Propane Refrigeration (SDP), Cascaded Refrigeration Compression (CRC), Gas Subcooled Processes (GSP), Recycle Split Vapor (RSV) can be selected prior to commencing with a demand and supply match.

At block 118, a volume optimization is performed. Volume optimization is based on a minimization of an objective function but can also be solved by other optimization techniques. Gradient non-linear is used in this edition with reduction of a cost function that is gas rate. Volume optimization is performed for the primary sales product example methane by minimizing the user entered demand vs the constrained supply after considering the four factors described herein. In embodiments, the primary sale product is gas. The primary product refers to the product produced according to the demand profile and the subject of matching. Products subject to matching include, for example, methane, ethane, propane, butane, pentane, condensates, Sulphur, and the like.

Based on the optimization results, there are three options the technical user can adopt at block 120. If constrained supply is equal to demand, process flow continues to block 122. At block 122, the user proceeds to perform the revenue optimization using a revenue optimization model. The external revenue model uses a method of unit technical cost (UTC), marginal technical costs (MTC) or long run marginal cost (LRMC) that identifies total manufacturing cost of 1 unit of the primary product that results in a Net Present Value (NPV) of zero. The total manufacturing cost includes the cost of making the primary product minus any revenue derived from sale of non-primary products. The option of NPV maximization can also be employed.

If the constrained supply is less than the demand, the process flow continues to block 124. At block 124, the tool proceeds to re-parameterize the models at block 112 and make user adjustments to increase the supply. In embodiments, this is done automatically. No revenue optimization is done at this stage since the products are not approved for sale.

If the constrained supply is greater than the demand, process flow processed to block 126. At block 126, interfield transfer option is evaluated using an interfield module that represents any external capacity connected by a means such as pipeline to transfer gas from one gas field to another. From block 126, two options exist to either transfer the products to another existing gas field at block 130 or the system proceeds to block 128. If the interfield volume is approved for use by the business user, the technical user can request to proceed with interfield transfer line that will subsequently proceed to revenue optimization 122. This is automatically done according to the present techniques. If the interfield volume is not approved for use by the business user, the technical user requests to reduce the cost function, and this reduced cost function is applied as constraint in the parameterization at block 112. In embodiments, the present techniques enable interfield system transfer to an underground or surface gas storage system. As stored gas is unsold, no revenue optimization is performed.

In embodiments, the present techniques enable simplification and reduce computational requirements needed for a large scale problem via normalized parameters between zero and one, (0 to 1) that describe the contribution of each node. This eliminates complexity, computational cost and time constraints associated with physics of large scale modelling particularly for demand and matching from reservoir scale across multiple field level.

The parameters for the workflow are selected and used as weighting factors to determine the maximum and constrained supply of the system based on wells performance, available facility capacity, reservoir or subsurface limitation and business decision factors. The scaling parameter value between 0 and 1 is determined by ratio of a specific node to the maximum of the specific node type. For well and facilities this can be done based on direct ratio calculation of the highest producing node to the lowest producing node or derived from machine learned regression models or equations. For subsurface, the scale ratio can be determined from results of existing analytical or numerical prediction model or applied directly by user. Business process factors are used to quantify contribution for investments decisions such as availability of excess capacity, market constraints or production agreements approved by regulatory body. In embodiments, business factors account for initial development plan of the facilities and excess or sub production that exist.

The demand and supply match as described herein is derived by solving for minimum objective function equations using non-linear gradient reducing method for this prototype stage of the art. More specifically the constraints must adhere as a minimum to the four normalized options or additional. A series of exemplary optimization equations are provided below:

$$Normalization per well node = {ω}_{well ( i )} = \frac{{q}_{rate well ( i )}}{{Q}_{max well rate in system}} \qquad Equation 1$$

$$Total normalized weight from wells ( wp ( i ) ) = well {( i )}_{wp} * {well ( i )}_{fo} * well {( i )}_{rm} * well {( i )}_{bp} \qquad Eqn . 2$$

$$Total normalized weight from manifolds ( mp ( i ) ) = \frac{manifold {( i )}_{q}}{max manifold ( q )} \qquad Equation 3$$

$$Supply per well ( i ) = wp ( i ) * w max rate * mp ( i ) \qquad Equation 4$$

$$Demand per well = \frac{well ( wp ( i ) )}{total ( wp ( i )} * Business user demand \qquad Equation 5$$

$$Non optimized rate = ( total system constrained supply - demand ) \qquad Equation 6$$

$$Proceed to optimization per time step$$

$$\begin{matrix}Minimize 〈 Total constrained supply - User demand 〉 \\ subject to change in cost function {Q}_{max well rate in system} \\ Proceed with next iteration as per work flow\end{matrix} \qquad Equation 7$$

By these equations, a normalization production module calculates the total weights for four options attributable to each well, platform or manifold. It defines the system constrained supply. The total weights applied to the references rates is used in defining the weighted constrained supply.

The present techniques are realized via a web based portal and an executed across large scale productions optimization to evaluate short term (<1 year balance), mid-term (1-5 years), and long term forecasts (5-25 years). The present techniques can also be deployed as module within a multi tool gas monitoring and production platform for larger scale visualization dashboards. The present techniques can be commercialized as standalone applications, APIs or DLLs focused on reduced computation requirements for such large scale matching problems. In some cases, the present techniques can be deployed as modules within a multi tool gas monitoring and production platform and is planned for future development and commercialization as a standalone software or algorithm that can be deployed across systems.

Generally, as provided by FIG. 1, the present techniques address demand and supply match using normalized parameter approach as opposed to full system physics. The present techniques are not limited to this approach and can still adopt full physics or a hybrid combination of options. The present techniques reduce the computational requirements associated with a large multiple field models. Various options that include coupling of high fidelity reservoir models have been considered but these options increases the complexity for such wide range models. The present techniques also enable simplicity in estimating the quantities from supply nodes such as reservoirs, wells, platforms, well manifolds, flow lines and gas plants. It can avoid the use of physics models and saves time associated with the constriction of these models. Specific to gas stream with simple dry to medium rich gas compositions, the present techniques simplify the gas processing operations. Moreover, the present techniques enable a reduction in time. In particular, the present computational time for matching is reduced from several days to shorter times in minutes to hours for large scale computation. Existing systems are delayed due to computational requirements but also business process delays in communicating requirements. The present techniques provide a simplified match that achieves similar accuracy by using constraints in the pre analysis and appropriate weights in the definition of the objective functions.

In embodiments, the present techniques include a hierarchical node setup. The proposed hierarchical technical solution to a problem of field to ultra large scale match of demand and supply for gas from multiple fields includes a node set up and weights as applied as described with respect to FIG. 1. A first node represents a total supply. For node one, unconstrained subsurface supply profiles are generated from existing full physics models or machine learned models. These unconstrained supply can be presented as gas potential or rate vs cumulative production (BSCF), hydrocarbon mass balance calculations (material balance), business generated production profiles, or any combinations thereof.

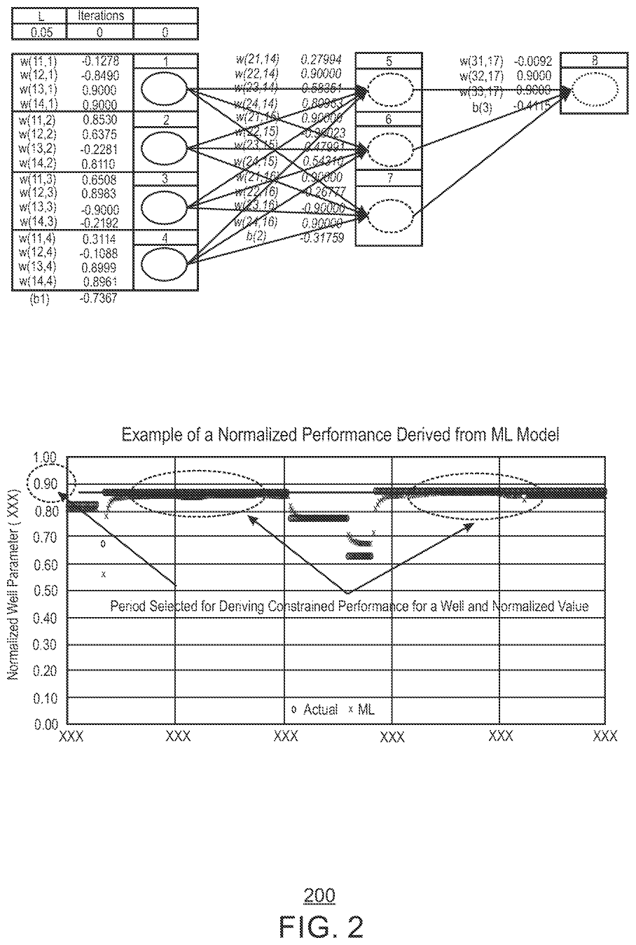

A second node represents well performance. For node two, normalized parameters are established from machine learning models, more specifically for well as these directly extract hydrocarbon gas quantities from unconstrained reservoir source. A parameter of 0 will be assigned to non-functional well or shut in wells while a value of up to 1 will be assigned to maximum producer wells for a particular field or in the system. Operating and healthy well will range between 0-1. FIG. 2 is an illustration of exemplary well normalization derived from machine learning that can be used for model initialization. A machine or data driven model that utilizes a combination of normalization, activation and backward propagation or such similar algorithm can be used to derive these normalized parameter for the wells. Neural Models such as an ANN 4×3×1 model are implemented. This parameter also indicates to the user the availability of such wells.

A third node represents facility operations (fo). For node three, normalized parameters are established by using known facilities parameters, maximum design rates and operating conditions (on/off). Facilities can include offshore facilities platform or well gas gathering manifolds in the case of land operations. More specifically for platforms a parameter of 0 will be assigned to non-functional facilities or shut in facilities while a value of 1 will be assigned to maximum operating facility for a particular field. This parameter also indicates to the user the availability of such facilities.

A fourth node represents reservoir management (rm). For node four, normalized parameters are established to address any specific reservoir controls that are not captured in the unconstrained supply data. Such normalizing can be used to address issues such as observed water encroachment, weak aquifer support, areas of poor reservoir quality etc. Similar to other parameters these normalized parameters can be between 0-1 in line with user requirements.

A fifth node represents business processes (bp). For node five, the objective of the business process parameter that can affect each node. In this instant, elements such as possible spare capacity or curtailment due to market conditions for each well can be added.

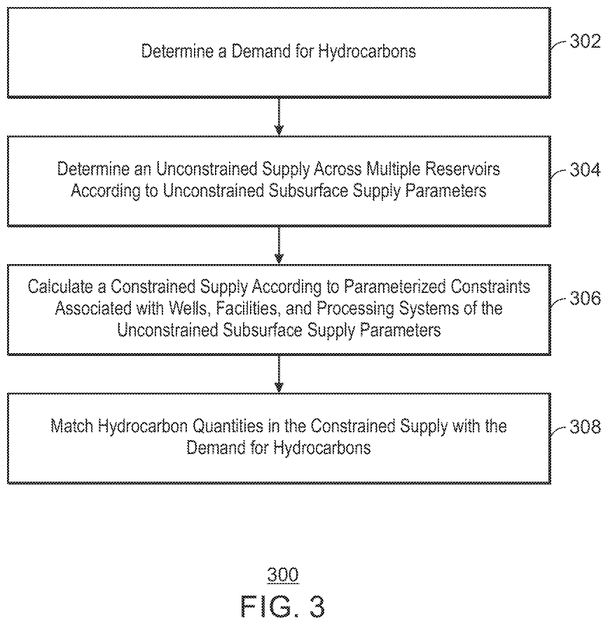

FIG. 3 is a process flow diagram of a process 300 for matching natural gas production with contractual quantities using normalized models.

At block 302, a demand for hydrocarbons is determined. In embodiments, the tool starts with total or unconstrained supply data from multiple reservoirs but can use other physics reservoir to surface modelling methods to generate such data. Error! Reference source not found. illustrates user options to create a network that achieves a match of to demand and supply.

TABLE 1

| User options | Examples of inputs used |
|---|---|
| Numerical physics | Full physics subsurface models that require |
| models | external connection tools |
| | Reservoir material Balance including P/Z models |
| Analytical/reduced | Mathematical forecasts derived from reservoir |
| physics model | engineering equations |
| Hybrid data from | Rate vs Cumulative production for given initial |
| physics model | subsurface gas volumes |
| Data only | Prediction forecasts in time from advanced |
| | numerical models |
| Normalized model | Machine learned reservoir, well and facilities |
| | models |

In embodiments, the present techniques utilize normalization factors that are weights. These weights lie between 0 and 1 with 1 representing the best performance of such facility in the nodes. At this stage, these weights represent the four operating factors that are: 1) Wells Performance Factor, 2) Facilities Operations Factor, 3) Reservoir Subsurface Factor, and 4) Business Process and Financial factor.

At block 304, an unconstrained supply is determined from multiple reservoirs according to one or more unconstrained subsurface supply parameters. In embodiments, the present techniques include an option for user parameterization of subsurface, well level and facilities information using automated scripts to perform physics driven analysis. In this approach wells and facilities can be classified in groups as opposed to providing details of a specific components (e.g., well or flow lines). As an example, well with similar completions and wells rates can be grouped and parameterized as a type. The results and performance of each type or groups can be reported in the product.

Additionally, in embodiments, the present techniques include an option for user parameterization of models with varying machine learning network architecture to utilize machine learned reservoir material balance models, wells or facilities to forecast production performance. Such machine learning models can be based on simple artificial neural network (ANN) or similar as the user will prefer or a hybrid of physics and machine learning models.

At block 306, a constrained supply is calculated according to parameterized constraints associated with wells, facilities, and processing systems of the unconstrained subsurface supply parameters. At block 308, hydrocarbon quantities in the constrained supply are matched with the demand for hydrocarbons.

In embodiments, the present techniques include an option to generate rates or supply profiles at well and facilities level that match specific demand, customer schedules or forecasts using unconstrained supply data from reservoirs and constraints that are based on normalized user input or machine derived parameters that define such constraints. Achieved match and in the case of a mismatch will be reported as an output according to the present techniques. In embodiments, the present techniques report capacities within a given system. The capacities include: 1) unconstrained supply capacity from reservoir sources; 2) constrained supply capacity after applying normalized weights from decision parameters; 3) spare capacity that can be produced but no demand; 4) spare capacity that can be stored using the tools interfield module and within the constrained interfield volume; and 5) undeveloped capacity that describes the part of the unconstrained capacity that cannot be supplied.

The present techniques enable calculating a gas demand supply match as a minimization problem of an objective function for both short term to long terms cases. In embodiments, gas demand and supply is referred to as a Short Range Operating Plan (SROP), Daily Contract Quantities (DCQ), and Annual Contract Quantities (ACQ). Further, the present techniques provide an option to match products specific demand/supply such as ethane, propane, natural gas liquids, and condensates based on given market factors or business operating scenario. The output according to the present techniques report the given supply with the constraints, or when below or above demanded quantities the present techniques report the mismatch.

Traditional techniques focus on a field only scale approach using physics models with increased computational requirement for large scale demand supply matching. The present techniques consider both a physics approach for supply nodes such as wells facilities, reservoir but also the option to parameterize the optimization problem using machine trained well models. i.e. data driven models. Further, traditional techniques solve optimization problems globally and maximize output based on given generic constraints. Users are required to evaluate predictions and the contribution of these constraining factors if maximum performance is not met post analysis. In the present techniques, the optimization problem is to solve the objective function to eliminate mismatch based on fixed constraining factors that are defined pre-analysis. More specifically, these fixed factors (pf) the present techniques include wells performance, facilities operations, reservoir and business process parameters. This approach simplifies computational requirements as the weighting of each of these factors is applied to an unconstrained supply profile provided by the user without a need to perform extensive computations to solve for the supply contribution of each node. For reporting and tracking purposes, these fixed constraints are also reported to guide the use on the reasons for a match or mismatch. Additionally, using the machine learning (ML) or trained or data driven option also provides a normalized parameter to be used to constraint well node supply. The ML models are trained to actual production data to drive an ML equation.

In embodiments, the present techniques include a gas plant element that replicates the process to convert raw gas to sales gas quality. This element is intended to reduce the computational requirements and avoids high fidelity gas plant processing models, and uses parameters derived from the gas processing association guide. The gas plant element also includes a functionality to process and recover liquids from gas stream. Also included in the gas plant element is the options to convert raw gas to sales gas and other products using either shrinkage factors or compositional properties of the feed stream. An option of multiple gas stream can be included.

The gas plant element has an option to specifically estimate the quantities of other non-hydrocarbon gases such as helium, CO2 and nitrogen levels that can be used for used to quantify commercial value of these streams, environmental benefits to improve environmental and safety goals of assets. Moreover, the gas plant element also includes a converter to convert and report gas quantities in oil and energy equivalent quantities such as standard cubic feet (scf) of gas to British thermal unit (btu) to barrels oil equivalent (boe). This conversion is based on predetermined conversion factors that can be adjusted in line with business needs.

Additionally, in embodiments the present techniques include a financial option for including wells, facilities and product expected revenues and running costs to derive short to long term optimization of unit production cost in energy equivalent terms of currency or similar standardized cost/energy key performance indicators. The units cost of production can also be reported as undiscounted breakeven costs of discounted unit marginal costs. The present techniques report each optimized result alongside matched demand or supply and differs from other tools that optimize use a net present value (NPV) system.

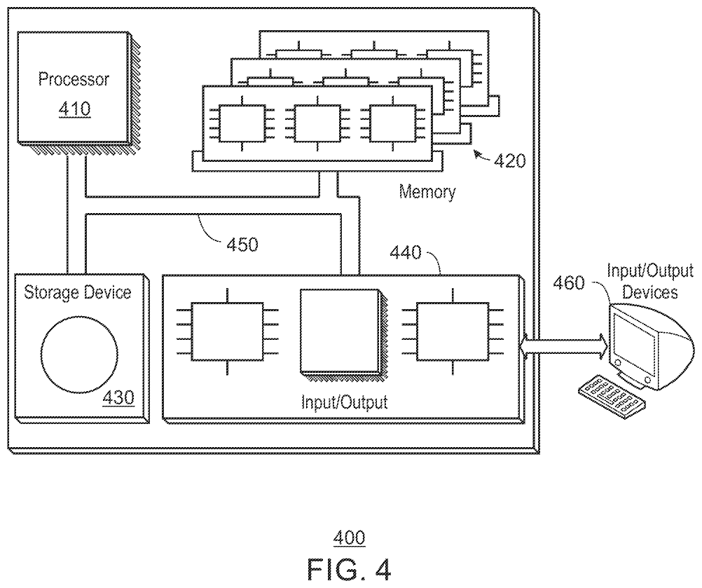

FIG. 4 is a schematic illustration of an example controller 400 (or control system) for matching natural gas production with contractual quantities using normalized models according to the present disclosure. For example, the controller 400 may be operable according to the process 100 of FIG. 1 or the process 300 of FIG. 3. The controller 400 is intended to include various forms of digital computers, such as printed circuit boards (PCB), processors, digital circuitry, or otherwise parts of a system for supply chain alert management. Additionally, the system can include portable storage media, such as, Universal Serial Bus (USB) flash drives. For example, the USB flash drives may store operating systems and other applications. The USB flash drives can include input/output components, such as a wireless transmitter or USB connector that may be inserted into a USB port of another computing device.

The controller 400 includes a processor 410, a memory 420, a storage device 430, and an input/output interface 440 communicatively coupled with input/output devices 460 (e.g., displays, keyboards, measurement devices, sensors, valves, pumps). Each of the components 410, 420, 430, and 440 are interconnected using a system bus 450. The processor 410 is capable of processing instructions for execution within the controller 400. The processor may be designed using any of a number of architectures. For example, the processor 410 may be a CISC (Complex Instruction Set Computers) processor, a RISC (Reduced Instruction Set Computer) processor, or a MISC (Minimal Instruction Set Computer) processor.

In one implementation, the processor 410 is a single-threaded processor. In another implementation, the processor 410 is a multi-threaded processor. The processor 410 is capable of processing instructions stored in the memory 420 or on the storage device 430 to display graphical information for a user interface on the input/output interface 440.

The memory 420 stores information within the controller 400. In one implementation, the memory 420 is a computer-readable medium. In one implementation, the memory 420 is a volatile memory unit. In another implementation, the memory 420 is a nonvolatile memory unit.

The storage device 430 is capable of providing mass storage for the controller 400. In one implementation, the storage device 430 is a computer-readable medium. In various different implementations, the storage device 430 may be a floppy disk device, a hard disk device, an optical disk device, or a tape device.

The input/output interface 440 provides input/output operations for the controller 400. In one implementation, the input/output devices 460 includes a keyboard and/or pointing device. In another implementation, the input/output devices 460 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier, for example, in a machine-readable storage device for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer. Additionally, such activities can be implemented via touchscreen flat-panel displays and other appropriate mechanisms.

The features can be implemented in a control system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include a local area network (“LAN”), a wide area network (“WAN”), peer-to-peer networks (having ad-hoc or static members), grid computing infrastructures, and the Internet.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

A number of implementations have been described. Nevertheless, it will be understood that various modifications may be made without departing from the spirit and scope of the disclosure. For example, example operations, methods, or processes described herein may include more steps or fewer steps than those described. Further, the steps in such example operations, methods, or processes may be performed in different successions than that described or illustrated in the figures. Accordingly, other implementations are within the scope of the following claims.

Other implementations are also within the scope of the following claims.

What is claimed is:

1. A computer-implemented method for matching natural gas subsurface production to contractual quantities, the method comprising:
determining, with one or more hardware processors, a demand for hydrocarbons;
determining, with the one or more hardware processors, an unconstrained supply from multiple reservoirs according to one or more unconstrained subsurface supply parameters;
calculating, with the one or more hardware processors, a constrained supply according to parameterized constraints associated with wells, facilities, and processing systems of the unconstrained subsurface supply parameters according to a selected model option;
matching, with the one or more hardware parameters, hydrocarbon quantities in the constrained supply with the demand for hydrocarbons.

2. The computer-implemented method of claim 1, wherein in response to the fluid quantities in the constrained supply being equal to the demand, executing a revenue optimization model.

3. The computer implemented method of claim 1, wherein in response to the fluid quantities in the constrained supply being less than the demand, iteratively parameterizing the wells, facilities and processing systems.

4. The computer implemented method of claim 1, wherein in response to the fluid quantities in the constrained supply being greater than the demand, evaluating an interfield transfer system.

5. The computer implemented method of claim 1, wherein the derived fluid quantities in the constrained supply are optimized based on, at least in part, minimization of an objective function;

6. The computer implemented method of claim 1, wherein the derived fluid quantities in the constrained supply are optimized based on, at least in part, volume optimization.

7. The computer implemented method of claim 1, wherein an unconstrained supply is determined according to gas potential or rate vs cumulative production (BSCF), hydrocarbon mass balance calculations (material balance), business generated production profiles, or any combinations thereof.

8. The computer implemented method of claim 1, wherein unconstrained subsurface parameters are weights between 0 and 1.

9. A system, comprising:
at least one processor; and
at least one memory storing instructions thereon that, when executed by the at least one processor, cause the at least one processor to:
determine a demand for hydrocarbons;
determine an unconstrained supply from multiple reservoirs according to one or more unconstrained subsurface supply parameters;
calculate a constrained supply according to parameterized constraints associated with wells, facilities, and processing systems of the unconstrained subsurface supply parameters according to a selected model option; and
match hydrocarbon quantities in the constrained supply with the demand for hydrocarbons.

10. The system of claim 9, wherein in response to the fluid quantities in the constrained supply being equal to the demand, executing a revenue optimization model.

11. The system of claim 9, wherein in response to the fluid quantities in the constrained supply being less than the demand, iteratively parameterizing the wells, facilities and processing systems.

12. The system of claim 9, wherein in response to the fluid quantities in the constrained supply being greater than the demand, evaluating an interfield transfer system.

13. The system of claim 9, wherein the derived fluid quantities in the constrained supply are optimized based on, at least in part, minimization of an objective function;

14. The system of claim 9, wherein the derived fluid quantities in the constrained supply are optimized based on, at least in part, volume optimization.

15. The system of claim 9, wherein an unconstrained supply is determined according to gas potential or rate vs cumulative production (BSCF), hydrocarbon mass balance calculations (material balance), business generated production profiles, or any combinations thereof.

16. The system of claim 9, wherein unconstrained subsurface parameters are weights between 0 and 1.

17. At least one non-transitory storage media storing instructions that, when executed by at least one processor, cause the at least one processor to:
determine a demand for hydrocarbons;
determine an unconstrained supply from multiple reservoirs according to one or more unconstrained subsurface supply parameters;
calculate a constrained supply according to parameterized constraints associated with wells, facilities, and processing systems of the unconstrained subsurface supply parameters according to a selected model option; and
match hydrocarbon quantities in the constrained supply with the demand for hydrocarbons.

18. The at least one non-transitory storage media of claim 17, wherein in response to the fluid quantities in the constrained supply being equal to the demand, executing a revenue optimization model.

19. The at least one non-transitory storage media of claim 17, wherein in response to the fluid quantities in the constrained supply being less than the demand, iteratively parameterizing the wells, facilities and processing systems.

20. The at least one non-transitory storage media of claim 20, wherein in response to the fluid quantities in the constrained supply being greater than the demand, evaluating an interfield transfer system.
